(19) United States
(12) Patent Application Publication
(10) Pub. No.: US 2013/0103528 A1
(43) Pub. Date: Apr. 25, 2013

(54) METHODS FOR USING A SHOPPING BAG OF REUSABLE TYPE WITH IDENTIFICATION OF DIGITAL TYPE

(71) Applicant: Vittoria Carnevale, San Lucido (CS) (IT)

(72) Inventor: Vittoria Carnevale, San Lucido (CS) (IT)

(21) Appl. No.: 13/699,320

(22) PCT Filed: May 17, 2011
(86) PCT No.: PCT/IB11/52160

§ 371 Date: Dec. 19, 2012

(30) Foreign Application Priority Data
May 21, 2010 (IT) RM2010A000267

(51) Int. Cl. G06Q 30/06

(52) U.S. Cl. CPC G06Q 30/0601
USPC 705/26.1

(57) ABSTRACT

A system for recording and identifying the single client—who usually purchases products with continuity in a business establishment or in a chain of business establishments—which employs a reusable bag associated with an identification that is integral therewith and also physically removable from the bag itself. A series of RF devices are provided for detecting and controlling (12, 16) the passage of the client who enters and/or exits from the business establishment, which refer to a resident electronic format archive (9). Payment can also be made via prepaid card/prepayment, and the verification that the payment elements belong to the actual owner is carried out on the basis of the identification codes associated with the bag.

### FIELD OF THE INVENTION

The present invention generally refers to a system which aims to incentivize the reuse of a bag for carrying out purchases in the same store and/or in the same business chain, by arranging prizes or discounts based on the fidelity of the client who reuses the bag.

### STATE OF THE ART

The utility model No. RM2007U000033 in the name of the same applicant discusses a particular bag constituted by different material types (paper, cardboard and thin cardboard which can be derived from recycled material or they can be of natural material, e.g. cotton, jute, nonwoven fabric or synthetic or mixed fabrics), of variable shape and size in relation to the type of purchase for which it is employed: if for purchasing products in wholesale and retail business establishments, or in supply chain stores with various shopping centers, or more specifically in specialized stores which deal with products of large or small size, such as pharmacies or libraries. This type of bag is reusable for the identification of a client who frequents a same store or a same chain of business establishments, since it is provided with an identification associated with the person who regularly makes the purchases. The identification of the client occurs by means of a bar code applicable in a removable manner to the outside of the bag. Each time the client enters the business establishment where he is registered, the bar code on the bag is read. Periodically, the detection is carried out of the number of purchases made by the client, or more generally the assiduity/continuity of the client in a given period is detected, thus determining the fidelity level of such client.

Applications are known at the digital payment level (electronic purse) which have the management of micropayments as objective. Juniper Research deems that such payment mode will affect over 2 billion people worldwide over the next five years. In addition, by the end of 2010 a European law is expected to become effective which establishes modes and procedures for systems of payment via cell phone in 27 countries of the European Community. Such laws make possible the access to forms of microcredit, up to 150 euros, as well as the management of cash for small expenditures; they are thus intended to revolutionize the habits of the generic client.

Also known are solutions in which a numerous series of products and services are purchased via cell phone. These include parking, museums, entertainment and ski passes. In this case, the cell phone is coupled with the bank card on which the micropayment will then be debited. It is even provided that by means of video cameras of the cell phone, one can read the bar codes of products, and purchase and payment are enabled with a simple click on the cell phone.

Beyond the specific use of the cell phone, the added value brought by the present invention to the preceding solutions is that a generic electronic device for telecommunications (which can be enabled to carry out micropayments as well) is made to interwork in real time with a card with identification code of a shopping bag in turn equipped with RF connection, activated in an automatic manner when the bag (with relative RxTx badge incorporated) is moved closer to the reader at the business establishment entrance, or to the electronic device for the telecommunications, which could be cell phone, a PDA or even a dedicated proprietary device.

Such devices, which originated for distance communications, in the context of cellular telephony are increasingly equipped with adaptive instruments that support advanced local communications in a variety of different situations and functionalities, such as: Bluetooth, or 802.1, local networks of wireless type (WLAN), WiFi and Wimax.

Another communications technique which is currently used in RxTx apparatuses of digital electronic type, such as cell phones, is the so-called “proximity communication” i.e. Near Field Communication (hereinbelow referred to as NFC). The use of the NFC interfaces in the apparatuses of cell phone type allows having portable devices with functionalities similar to those of the cards/badges with integrated circuit (i.e. the RFID cards with radio frequency identification). In addition, such electronic devices supplied with NFC interface are capable of operating both as radio frequency readers and/or they are capable of writing in order to communicate with other devices which always operate at the NFC level.

For example, the recent Nokia™ model 6212 has a NFC Bluetooth protocol (Near Field Communication) which allows exchanging files and information with other enabled devices by lightly touching them with the same phone. In this manner, one passes a photograph from one phone to another without having to first wait for device recognition, or one passes the photograph to the printer by touching the latter lightly; above all, with regard, to the present invention, the cell phone is used for payments like a credit card, i.e. by lightly touching the sensor of the checkout counter (adding a possible PIN).

The object of the present invention is to provide a solution for using a shopping bag with identification of digital type in which the identification (which in the preceding embodiments was always constituted by a bar code integral with the reusable bag) comes to be physically associated with the bag itself by means of a digital card or “badge”, or better yet smart-card, of contactless type. The card must operate at radio frequencies, since a minimum or zero action is requested by the client who certifies the card in his possession via the passage—without, for example, having to search for the badge in the bag or wallet and then having to manually pass it under the reader. For this purpose, client recognition techniques are used of biometric type, such as the facial image recognition.

A further object of the present invention, in addition to providing techniques for RF recognition of the authenticity of the bag identification, is to implement a mode for activating a secure data exchange between the badge card and the reading system, in order to allow the use of cards or badges for those services which require the functions of credit addition or prepayment, in a manner so as to enable the access to corresponding payment services and expenditures such as electronic purse.

The object of the present invention is also to provide a method for using a shopping bag with identification of digital type which allows the “loyal” client to locate the various discounted products, as a reward for the consistent loyalty/trust, by means of an interactive guide that is enabled by the RF card contained in the reusable bag.

Still another object of the present invention is to provide techniques and devices for using a shopping bag with identification of digital type that allows managing the control and the identification of the nearby presence, via the use of means deriving from WAN connections in mobile telephony as well as of typical RFID technology means with short range passive connection, by providing for the interworking of the different radio frequency devices and technologies employed.

Finally, another object of the present invention is to provide techniques for using the shopping bag with identification of digital type which employs basic protocols and standard rules in the scope of mobile communications and of the relative authentication of the parties, for the purpose of facilitating the exchange of the functionalities associated with each device, and in a manner so as to render the same methods readily feasible.

These and other objects which will be clear over the course of the description are obtained by means of implementation characteristics summarized in the enclosed claims.

### BRIEF DESCRIPTION OF THE DRAWINGS

The invention will be better comprehended from the reading of the following description, provided merely as an example and with reference to the drawings, in which:

FIG. 1 is the representation of a card, such as a badge, that can be inserted in a removable manner in a recyclable bag according to the invention,

FIG. 2 is a schematic representation of the steps relative to the use of the reusable bag, in the scope of a business establishment.

### DETAILED DESCRIPTION OF PREFERRED EMBODIMENTS

In the embodiments described below, with reference to the drawings, the components are not necessarily in scale and are only reported with functional blocks, the emphasis being placed instead on the general, fundamental principle of the invention.

The production of devices such as badges, cards and other contactless devices is in great expansion. Many systems of identification, payment or credit, the ATM systems, the access control systems etc., make great use thereof. Up to now, the functionalities requested by these devices have been increasingly complex. In the present embodiment, several solutions are configured in which the interworking is provided with other personal identification instruments such as the telecamera for the facial recognition of the client, or the cell phone in NFC and/or Bluetooth functionality.

The general inventive concept is in any case grounded in the use of a bag to be reused. The change with respect to the original solution—based on the identification by means of bar code—provides, in this embodiment type, that the identification instrument of the possessor must also be based on the techniques of biometric recognition, such as recognition of the facial image, on badges with identification of contactless type, and on cell phones or other electronic devices for radio frequency telecommunications.

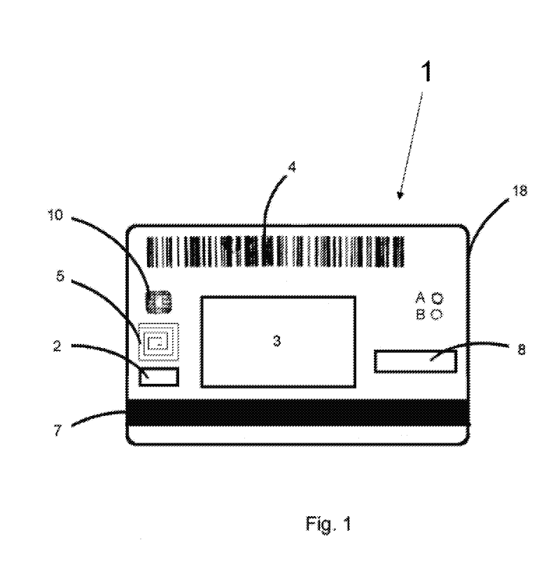

The fundamental principle is to provide an efficient and user-friendly service for users, also at the price of excessive redundancy of employed means. It is wished to avoid that the client is obliged to use the recyclable bag each time, and at the same time it is desired to ensure that the client is sure that he can use the bag once he is in the business establishment, that he will definitely be able to accumulate points with regard to the purchases made. For this reason, two or more redundant identification means are used, to be employed in sequence (if one does not function, the other is used) or in parallel. In particular, the bar code 4 visible on the card in FIG. 1 corresponds to the digital identification for the facial recognition stored at binary level in a memory 8 of the card itself.

The use of the facial recognition instrument is preferred at the moment, since it allows, with respect to other techniques such as the recognition of fingerprints. With facial recognition, the client can pass through the entrance 11′ without having to complete operations of any kind, since in most situations there would be immediate recognition. Such method also allows interaction with the human operator: in case of non-recognition, the client moves himself with respect to the telecamera 16′, 16″ in order to ensure that the recognition occurs.

Currently, this type of biometric identification has a high recognition rate under controlled conditions. But in the end, if recognition by the telecamera 16 is unsuccessful, the identification occurs in a direct manner, by means of scanning by the set reader 12 of the bar code corresponding to the image of the client's face and to the relative card. The recognition occurs by the employee of the service center by means of comparison of the client's face at the entrance with the image obtained from the user data bank 9, which is reported on a display.

When the telecamera 16 executes the facial scanning of the client according to the predefined transcoding algorithm, a dedicated processor immediately actuates its conversion into a binary code constituting the imprint, and at the same time executes the comparison with the code stored in the smart card 1 at the time of issue of the same. Such stored code also corresponds with the coding of the client's facial image at the time of card issue, when the digitized information is stored in the smart card with regard to the user's facial recognition, obtained from the processing of the image of the user himself.

The comparison occurs at RF by means of comparison of the string of bits contained in the card with those resulting from the current facial detection. This is conducted for the purpose of making the identification automatic and fast.

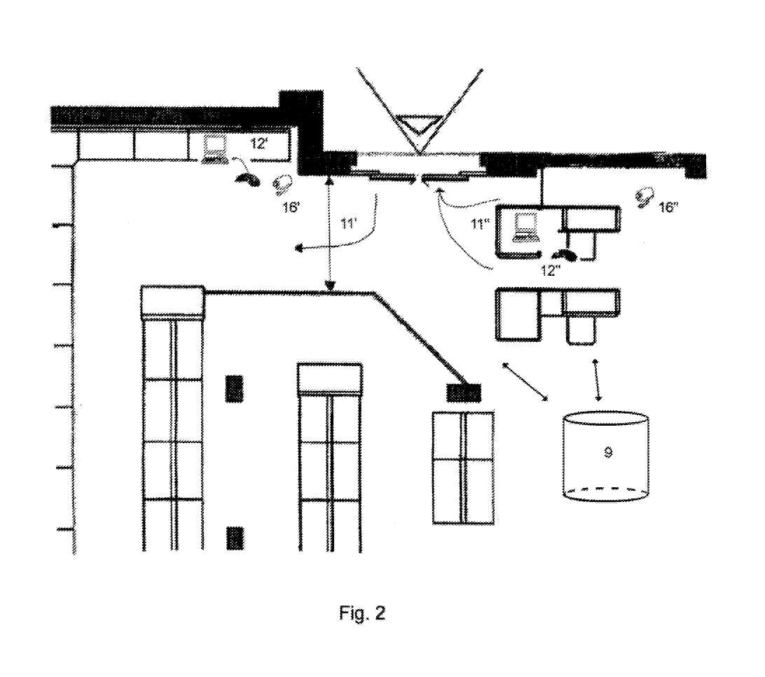

In order to access the business establishment, the client passes through an entrance each time, which is predefined for those in possession of the bag with smart card. With reference to FIG. 2, this figure illustrates an area with two accesses 11′,11″, which could be two classic passages, respectively entrance/exit passages of a supermarket. Reported in such schematic representation are the different sequential activations of the signals and the commands activated each time in order to implement the facial recognition of the client.

One or more devices, such as the telecamera 6′, are arranged on the entrance 11′ at the dedicated entrance for the user in possession of the bag with relative RF badge. Upon accessing the commercial area, through such door 11′, the device 16 activates a procedure for controlling the validity of the badge card 1 of the client, which is inserted in the bag in his possession.

The telecamera 16 carries out a digitizing of the image for a first possible recognition at RF through the comparison—carried out by a dedicated processor—of the information related to the image stored in the card 1 to that currently detected by the telecamera system. If the user is not recognized, he moves himself with respect to the telecamera 16 in a manner so as to change the filming angle, and if he is still not recognized he is requested to be manually identified through the scanning of the bar code reported on the same smart card 1 in a visible manner in zone 4. In both cases, following recognition, the first of the two LEDs A and B of the badge are turned on; this indicates a state of alert or that presumed possible purchases have been carried out, and then there is another passage, this time at the checkout counter, for proving that the purchases were actually made. This prevents fraudulent use, i.e. it avoids that by means of back and forth passages before the facial recognizer, based on the telecamera 16, a person can acquire points, in cases when the score derives only from the number of entrances and not from the size of the bill.

The fundamental access document for the present invention is therefore a card 1 with on-board electronics and stored data. The card 1, being the document for access or that which gives the right to the service, comprises data therein for the facial recognition and the authentication of its carrier; such data is encrypted and the encryption key is preserved inside a SIM 2 thereof—not to be confused with the SIM of the cell phone, but having a same functionality as Subscriber Identity Module.

Currently, there are smart cards of different type available, but for the object of the invention, the family of interest is the “contactless” card; here, the RFID card is only read if it is found between a minimum and maximum distance from the reading system, and physical contact is not necessary. It should be recalled that RFID is the acronym for Radio Frequency IDentification. It constitutes a technology for the automatic identification of objects, animals and people. The system is based on the reading at a distance of information contained in a RFID tag, by using the RFID readers. A RFID tag is generally constituted by a microchip that contains data (including a unique universal number written in the silicon) and an antenna that allows receiving and transmitting at radio frequency from a RFID transceiver. RFID technology has several advantages with respect to conventional technologies, which were based on bar codes and on magnetic bands:
It does not have to be close in order to be read, as is the case for magnetic bands;
It does not have to be visible in order to be read, as is the case for bar codes;
Information can also be added on the chips as a function of the chip type (Read Only, Read Once, Read and Write);
The identification and the verification occurs with times on the order of a hundredth of a second;
The communication can be encrypted or non-encrypted.

In reality, in the evolution of the original solution with the present invention, the presence of identification instruments via contact is not excluded. As reported in FIG. 1, the presence of bar codes 4 and magnetic band codes 7 are still provided, together at least with a RFID tag 5. In substance, a combination of known means is used in order to make the system more reliable and efficient.

Indeed, several solutions are even provided in which the smart card is equipped with microprocessor 10, memory and bus with high processing capacities, since this is required for sophisticated processing activities such as adding and subtracting credit from the prepaid card/prepayment.

Another type of badge, described below in the invention, has minimal cost as it can be made low-level, with minimal work potentialities, since it must be adapted to execute only a small quantity of data processing over time. In this case, the storage and processing of the data is delegated to the cell phone, currently provided with considerable storage capacities and potentials.

FIG. 1 shows a plate-like support 18, with the following components mounted integral or on the surface:

a CPU 10, a client identification medium 2 with relative algorithms and encrypted keys stored therein, a photovoltaic cell 3, with a power supply circuit and capacitive circuits and/or rechargeable battery, one or more RxTx (RFID) units 5, with relative antenna.

In particular, the latter component, in the application that provides for the management of a prepaid card/prepayment for paying the purchase bill, allows operating with contactless carts, whose transponder operates at a frequency on the order of 13.56 Mhz. They are differentiated from the Low Frequency Cards (125 Khz) essentially due to the functioning distance, the data transfer speed and the memory capacity. Given the same data transfer speed and with respect to the 125 Khz transponders, they can operate at greater distances (ISO 15693). Still with respect to the 125 Khz transponders, but given the same functioning distance, they can operate with an increased data transfer speed, with the consequent possibility to increase the quantity of the data exchanged and hence the memory capacity (ISO 14443).

The CPU 10 constitutes the intelligence of the smart card 1 which must execute the procedures stored in the internal program-data memory 8, adapted to produce the coded data exchange with a reader device 12 for managing a prepaid card/prepayment for paying the bill at a checkout counter; and it acquires the points relative to the shopping made after the cashier has established the ownership of the bag in real time. In fact, on a display available to the cashier, the latter can each time view the face of the client already stored in an archive of the business enterprise, the relative search being actuated on the basis of the imprint stored in the smart card 1 starting from a contactless connection with a reader 12 placed near the checkout counter. If this first connection type at RF is unsuccessful, as stated, the cashier carries out a manual reading of the bar code 4 reported on the cart 1, visible on the outside of the reusable bag.

The CPU 10 always functions in energy savings mode, and switches to the active state only when the RFID circuit is activated by the reader close to the checkout counter, and only for the time necessary for the transaction. The CPU 10 activates the coded data exchange with known encryption algorithms. Such encryption key, as stated, is protected and resides in the medium 2, the identification of the client, constituting part of the smart card.

The identification medium of the client 2, with identification derived from the digitizing function, is protected by a local code stored in the CPU firmware and used by the latter for activating its functions. The attempt to read the identification medium of the client with an incorrect code causes the permanent locking of the client's identification medium. The identification medium of the client 2 contains the various files at its interior in which the keys are preserved relative to the facial recognition for the identification and authentication in transferring the encrypted data; such data is transferred in one direction or the other during the exchange of information (derived from the scanning of the client face and contained in the memory unit 8 of the smart card 1) with the device 12 which controls the access based on said facial recognition.

A fundamental characteristic of the technique according to the present invention is the type of power supply, which provides the power for the reception and transmission of the information; such power supply is based on the fact that the smart card is arranged in a removable manner on the bag exposed to outside light, at least when the client arrives to make purchases.

Indeed, on the surface of the card 1, a photovoltaic cell 3 is arranged for obtaining energy from the external lighting, extremely intense in the business establishment setting. Following the conversion, the energy produced by the photovoltaic cells 3 is stored in capacitive circuits or rechargeable batteries not reported in the figure.

The RFID transceiver 5 with a screen-printed antenna has the task of waking the CPU 10 when the latter is interrogated, and activating the data reception and transmission at radio frequency.

As already mentioned, one application referred to the purchases at a business establishment is the use of the smart card (object of the invention) as item for paying the bill at the checkout counter. At the entrance 11′ of the business establishment, after the step of facial recognition or by means of bar code, the device 12′ controls the validity of the smart card and whether the credit is sufficient. A possible LED display on the smart card 1 signals the balance status for the prepaid account, or it signals insufficient credit. The endorsement and relative deducting of the purchases from the current account balance automatically occurs when the client submits his own purchase to the calculation of the checkout counter together with the bag that contains the identification card.

When the client in possession of the bag approaches the checkout counter, the same client is framed by the telecamera 16″, and from the relative photographs a dedicated processor obtains his identification for the recognition. At the same time, the comparison is carried out with the code present on the smart card 1. In addition, the smart card 1 is interrogated when it is situated near the reader 12″, and the transceiving circuit 5, upon recognition of the command, transmits its own alphanumeric identification.

The reader system 12′ that comes to be aware of the presence of the smart card 1 in its area starts a protected data exchange with the card itself. At the final user level, the checkout counter employee executes the relative bill and provides that the payment is carried out by reducing the relative prepaid amount from the card 1. Two instruments for authenticating card ownership are provided: on one hand, the telecamera 16″ took photographs of the client approaching the checkout counter and the comparison with the identification was carried out for the facial recognition, with a visual indication of success or failure; on the other hand, at the cashier, the image (the face) of the client appears on a display, such image retrieved from the proprietary archive 9 of the business establishment, on the basis of the identification contained in the card itself and acquired by means of RF connection. If the image does not coincide, the cashier makes use of the bar code 4 on the card, by means of the manual reading of the same for the retrieval of the image in the proprietary archive.

The reader system, having ensured the security of the data deciphered in a correct manner, can update the information contained in the smart card 1 by reducing the prepaid amount or updating the spendable residual amount.

A system of antennae inside the business establishments, arranged in a distributed manner, allows the simultaneous reading of all the smart cards, one for each checkout counter. Each reader 12 at the checkout counter provides for the verification of the authenticity of the encryption keys of each smart card 1 and possibly the subsequent endorsement or deducting or charging of the bill due to each smart card in addition to the accumulated score, rewriting the data on the memory of the smart card.

The bill payment instrument at the checkout counter of the business establishment therefore comes to be the smart card 1 with the relative prepaid amount. Since the latter is inserted in a bag which comes to be reused, it is possible to associate the purchases just made with a given score, which is proportional to the size of the paid bill.

As stated, the smart card is per se an extremely widespread application, but in the present invention the specific use provides for several characterizing functionalities:

1. The smart card 1 itself, comprising the identification of the bag and thus of the client, constitutes the payment item, since it can be credited according to client needs, with transactions which make use of proprietary encryption algorithms.

2. The smart card 1 is endorsed, electronically deducted—for each expenditure, and a score is updated therein relative to the size of the expenditure made; such purchase is made inside the business establishment where a great number of smart cards are simultaneously present that are similar but have different identification. Even in the case of numerous smart cards present near each other, the authentication algorithms for the detection of the data contained in the smart card 1, without interaction errors, solve the exchange by themselves forming part of the software of the reader 12 and of the firmware of the card. In case of lacking identification by means of RF facial recognition, the key operates by means of the corresponding bar code 4.

3. All the credit addition/subtraction transactions with electronic charge of the bill cost occur with encryption algorithms, with the use of inaccessible encryption keys residing on identification mediums of the client 2. Such transactions take place with the establishment of the actual ownership of the client bag, in real time by the cashier, via comparison of the face with the relative stored image.

The communication protocols currently provide for the use of four encryption keys:

1—The RF identification key (corresponding to the bar code 4) which authenticates the access of the client entering/leaving the business establishment.

2—The key for adding credit to the smart card 1 in suitably arranged machines.

3—The key for the dynamic updating in real time of the data contained in the card 4 (e.g. size of the residual prepaid amount and acquired score).

4—The key for controlling or testing the card status, by equipment set for the verification.

In a further embodiment of the present invention, the coupling or interworking is considered of the contactless badge inserted in the bag with the cell phone usually in the client's possession. The recording and recognition system according to the present invention in this case operates with five distinct components; interworking with each other, these can be considered as logically integrated in a single system:

a—the first is the bag,
b—the second is the badge card 1, i.e. the access authorization item, which contains the encrypted data that characterizes the user/client and is physically integral with the bag to be reused,
c—the third is the telecamera set to detect the client's photograph,
d—the fourth is the NFC and/or Bluetooth cell phone,
e—the fifth is the reader 12, positioned at the checkout counter, generally connected to a Host Computer.

From the functional standpoint, when the badge card 1 is situated near the phone, it is interrogated. The transceiving circuit recognizes the command and transmits its own identification register number. The performances offered by a badge with tag of standard type can themselves be optimized when the interworking of the badge 1 with a cell phone is considered, e.g. interfaced by means of Bluetooth.

The fundamental principle in this embodiment becomes that of maintenance and detection of the connection at each instant, hence in real time.

The recognition procedure upon entering remains the same. When the detection system 12 at the entrance detects the presence of a smart card 1, it carries out a series of photographs of the user, on which a face-cropping operation is executed. The algorithm which executes the coding of the image of the face lacking background is not examined herein, since one can find ample, in-depth technical literature on the matter. The key—or imprint—obtained by means of the aforesaid algorithm is compared with the key stored in the smart card 1. In order to actuate such comparison at the same time as the photographic detection, an RF reading request is sent from the reader system 12 to the smart card 1 so that the relative CPU is activated and the key is sent in encrypted manner from the smart card to the reader system 12 for the comparison.

However, in this second embodiment, the client in possession of the bag equipped with RxTx badge is also connected to the phone with the Bluetooth, with a suitable signaling which indicates that the unit 12 for controlling the entrance/exit of the business establishment—based on facial recognition of the client—has picked up the entrance.

Together with the cell phone of recent production, equipped with Bluetooth connection, the transceiving device (card, badge) is used that is removably inserted in the recyclable bag of the client, it too equipped with transceiving device of Bluetooth type. Such badge card, in addition to being used for the recognition of the entering facial image, also comprises an electronic device—with relative photovoltaic power supply—which continuously transmits, over Bluetooth frequencies and with Bluetooth protocol, its presence to the cell phone in the client's possession. Even if this is not the requested base functionality, the phone is capable of producing an alarm when the card and, thus the bag, is at a distance greater than X meters (e.g. due to theft or for forgetfulness). Of greater interest with regard to the interworking between the card/badge, integral with the bag, are the possibilities for identification and authentication of the client in possession of the bag by means of accessory functionalities such as those described below.

From the operative standpoint, before being able to use the application, it is necessary to activate the Bluetooth on the cell phone. Hence, in order to associate the bag with the relative badge devices to be monitored, the first operation to be executed is an initialization procedure. The identification code also in this configuration derives from the key coming from the facial scanning of the client, which thus comes to constitute the unique identification also for the Bluetooth connection.

The badge equipped with Bluetooth tag has a small LED which informs on the connection status of the system. For the entire time in which the badge equipped with Bluetooth tag and the cell phone connected thereto are kept at a distance less than that predefined, settable at the time of configuration, a presence flag is activated in both devices.

In order to be able to use the badge, it will suffice to install the suitable application (e.g. in Java on one's own cell phone). The relative configuration is delegated to the customer care service center of the shopping center. From the cell phone application, in a first initialization step, the connection to the badge is carried out and the functioning of the same is set, modifying the parameters according to client needs, such as the activation distance.

The transmission functionality tests provide for a simulated generation of an alarm situation due to distancing of the badge from the cell phone. The operation is repeated until the bag with the badge is detected by the cell phone.

Once the device has been detected and selected, it enters into a procedure for attributing the identification of the badge to which the cell phone is associated. In substance, the principle holds according to which a cell phone (i.e. a SIM) is associated with N badges and/or also that M cell phones are associated with one badge, in a N to M correspondence. For example, reference can be made to a family with M cell phones and N shopping bags, with the members who go shopping depending on the occasion—even two, three people at a time all together. Or the case of a restaurant or mess hall, corresponding to a client who shops each day with three, four bags, each equipped with badge, capable of being connected to a cell phone in Bluetooth.

The coupling occurs by associating the identification of the client—deriving from the scanning of the relative facial digitizing—and the relative badge with cell phone, so that the preceding operations are repeated each time one wishes to associate another bag with the cell phone.

The application provides that once the log-in has been carried out upon passage with the bag and with the cell phone at the entrance block, with the telecameras that carry out the facial recognition (which in addition to identifying the user, subsequently serves for carrying out and recording the various purchase and/or point increase operations), given that the presence of the badge has already been detected by the cell phone, a control procedure is activated that in turn goes immediately into background, allowing the continued normal use of the cell phone.

Based on the number of bags possessed by the user, during monitoring the Bluetooth signal is in any case detected by several badges, with a procedure of polling type; this occurs even if the application passes into foreground only when it returns to a checkout counter for carrying out the payment of the day's purchases. This due to the fact that after a bag/badge device has been associated with the SIM of a cell phone, it is automatically included in the list of devices to be monitored, when its presence in the vicinity of the cell phone itself is detected.

In a series of preferred embodiments of the finding, the management of user groups with prize competitions is provided for; in such groups, situations are generated with apparent conflict, and competitive solutions are sought by means of optimization models and strategies.

The implemented solutions are based on the principle of defining user communities, each user defined by his own cell phone or by one or more bags with digital badges registered on the relative cell phone.

With regard to this competing use between a plurality of users of the cell phone service, each with one or more bags with relative Bluetooth bag support, different use possibilities are identified. Such is the case, for example, of a factory or company store which actuates a fund collection deriving from the points and the amounts of each bill/purchase, with final classification of the person who spent/contributed the most, always using the same bag—the same bags—for making the purchases.

It should be noted that with the increase of the number of expenditures made and points accumulated, the bag itself, with the relative badge, acquires a significant value. It is useful then to configure the alarm mode. This can be configured with the usual options (vibration, ring, vibration and ring) and the alarm is activated when the bag is at a distance of greater than 5 meters from the cell phone.

In the embodiment that provides for the bag/badge/cell phone configuration, the latter is attributed the Near Field Communication (NFC) functionality for contactless payment.

Such wireless payment system allows carrying out the payment of the purchases by means of a short distance transaction. It is sufficient to bring one's cell phone or PDA close to the checkout counter which calculates the final bill and which is equipped with NFC reader.

It should be underlined that if on one hand, the present application is based on the characteristics of the NFC, on the other hand the simultaneous interfacing with the technologies relative to facial recognition (WiFi, Bluetooth etc.) is fundamental; hence, upstream of the relative applications, a three-part enabling protocol is activated. Such enabling is based on the identification based on facial recognition (a) of the client, upon establishment (b) of the Bluetooth connection in the presence of the bag/badge card in the vicinity of the cell phone, the connection configuring a continuous alert status on the basis of which the possible detection (c) of an approaching smart—checker checkout counter is requested (with a polling, for example). Such checkout counter is situated at the exit of the business establishment; such detection is undertaken in order to activate an authenticated bill payment procedure by means of a NFC process.

A further embodiment of the present invention provides for the possibility to guide the client in possession of the bag with badge in the selection of a series of products on sale. This embodiment is implemented with WiFi connection (without cell phone, even if the cell phone/Bluetooth/bag configuration discussed above would also be practical for this embodiment type).

Indeed, one provides for the coupling of the bag with a (display) visor integrated or inserted in the shopping cart. In practice, after having carried out the log-in upon passage through the entrance block (which in addition to identifying the user via facial recognition or scanning of the bar code, will subsequently serve for carrying out and recording the different acquisition operations) through WiFi connection, a list of products appear to the client on the display which are only on sale for card/badge owners. Subsequently, through the WiFi location and orientation system, the client can direct himself inside the business establishment—one should consider multilevel shopping malls or those with great extensions. On the reader screen, a point will appear that indicates the client's current location in a mapping of the room where the aforesaid offer can be found (For example: DO-IT-YOURSELF area, lateral corridor, first shelving second level, paints and impregnating substances section).

In practice, a virtual map of the business establishment is provided for, and a client can move such map in an interactive manner. For example, by means of a touch screen keyboard operating in RFID, on the visor inserted in the cart, so that the client can acquire information on the current location and from the client database.

From the structural standpoint, the activation of the intelligent display is actuated by the badge by means of the physical insertion of the badge itself in the display unit. The badge is made integral with the bag, for example by means of a sealed small chain, or it is based on the radio frequency coupling, still of contactless type.

Following activation, the client is presented with a list of products that are only on sale to those in possession of the bag/badge.

The client, once he has selected the particular product of interest, can head in a guided manner to the shelving where the product is located. By bringing the cart close to the shelf, the client is able to obtain all the information on the product on sale (from the shelf itself provided with RFID tag), and is able to obtain his points situation in real, possibly in relation to the product type.

The reader/display on the cart is in fact connected, still in WiFi, to a database 9 of the clients in possession of the bag; and in relation to the client and to the history of the shopping carried out, a purchase invitation message is obtained of the following type: “Special promotion in the dairy section—you have 350 points now, and if you reach 380 you can have a table setting.”

Payment could occur directly via the reader.

### ADVANTAGES AND INDUSTRIAL USES OF THE FINDING

The detecting and controlling devices are easy to place in a setting, and the integration thereof is possible in all system types. The application is developed in the field of cellular telephony for all currently available operating systems.

The installation of the application on a cell phone is carried out by the Service Center of the shopping center by means of a self-installing CD; or, without a computer, via Internet access to the website set for downloading the installation program.

From a strictly commercial standpoint, various scenarios can take shape which propose the system to the user:
A—The network operator launches a point collection campaign together with a business enterprise chain, and it is possible to lock the application in order to prevent the functioning with SIM of other operators.
B—The commercial chain in accordance with the phone network operator launches a point collection campaign, in which the points attained from the expenditures in the business establishment can be used for carrying out cell phone traffic, or vice versa.
C—The network operator launches new content to be downloaded on cell phones and the operator itself acts as intermediary for advertizing a series of products on sale and/or with which one can accumulate points.

1. A system for recording and identifying the single client who purchases products with continuity in a business establishment or in a chain of business establishments, characterized in that it employs:
i—a reusable bag associated with identification means that are integral therewith and physically removable from the bag itself;
ii—devices (12, 16) for detecting the passage of the client who enters and/or exits from the business establishment;
iii—electronic format archive (9), situated at the business establishment, comprising at least the information relative to the identification of each client and to the calculation of the number of accesses or of the size of the purchases made by the client,
iv—memory devices (2, 4, 7, 8) comprised in the identification means, which are integral with the client bag and physically removable therefrom, in which the number of entrances/exits by the single client and/or information related to the size of the purchases made each time are recorded;
v-a—means for paying the purchase bill via prepaid card/prepayment, the verification that the aforesaid payment means belong to the actual owner being carried out on the basis of the identification codes associated with the bag;
v-b—means for interconnecting and interworking between said identification means, physically removable from the bag, and a cellular telecommunications device possessed by the client, set for paying the bill via NFC prepaid card/prepayment, the control and verification that the aforesaid cell phone belong to the actual owner being executed on the basis of the identification codes associated with the reusable bag.

2. A system for recording and identifying the single client who purchases products with continuity in a business establishment according to claim 1, characterized in that the identification means, physically removable from the bag, are constituted by a digital access card (1) comprising its own memory unit (8) with a digital identification for actuating a card holder facial recognition and authentication method, such identification being encrypted by means of encryption key preserved inside a SIM (2), the digital identification for the facial recognition recorded in the memory unit (8) of the card (1) corresponding with a bar code (4) visible on the card.

3. A system for recording and identifying the single client who purchases products with continuity in a business establishment according to claim 1, characterized in that the following are included on the digital card (1): a magnetic band (7), a CPU (10), a photovoltaic cell (3), with a power supply circuit and capacitive circuits and/or rechargeable battery, one or more RFID RxTx units (5), with relative antenna, a memory unit (2) dedicated to containing the encryption and authentication keys for the facial recognition and a memory unit (8) with the various files in which the digital data is preserved relative to the client's facial recognition, to be employed for the relative identification on the basis of the authentication and (de)ciphering process actuated via the authentication keys contained in the identification medium (2).

4. A method for recording and identifying the single client who purchases products with continuity in a business establishment according to claim 1, characterized in that it comprises the following operating steps:
a—at the time of access to the business area, a detection device (16), such as a telecamera, activates a procedure for controlling the validity of the RF card (1) of the client inserted in the bag in his possession,
b—the telecamera (16) takes a series of photographs and carries out the relative digitization of the image for a first possible RF recognition through the comparison—made by a dedicated processor—of the data related to the image stored in the card (1) with the data currently detected by the telecamera system,
c—1 if the user is not recognized, he moves himself with respect to the filming device (16) so as to change the filming angle,
c—2 if the user is still not recognized, he is requested to be manually identified through the scanning of the bar code which is situated on the same card (1), in a visible manner, in zone (4) of the card.

5. A method for recording and identifying the single client who purchases products with continuity in a business establishment according to claim 1, characterized in that the identification of the bag and thus of the client is included in the contactless card (1), and the card itself constitutes the payment item, since credit can be added thereto—according to client needs—with transactions that make use of proprietary encryption algorithms, so that when the client enters the business establishment, the detection devices such as the telecamera (16) execute the facial scanning of the client according to a predefined transcoding algorithm, a dedicated processor immediately actuates its conversion into a binary code constituting the identification and, at the same time for the purposes of payment authentication, executes the comparison with the code stored in the card (1) at the time of issue of the same, such stored code also corresponding to the coding of the facial image.

6. A method for recording and identifying the single client who purchases products with continuity in a business establishment according to claim 1, characterized in that a checkout employee establishes the bag ownership in real time, on a display available thereto which each time displays the face of the client previously stored in an archive (9) situated at the business establishment, the relative search being actuated on the basis of the identification stored in the card (1) starting from a contactless connection with a reader (12) placed near the checkout counter, and following the successful establishment of the actual ownership of the bag, the CPU (10) inserted in the card (1) executes the procedures stored in the internal program memory (8), adapted to produce the coded data exchange with the reader device (12) for managing a prepaid card/prepayment for the purpose of paying the bill at a checkout counter and acquiring the points related to the shopping carried out, and in that if such first RF connection type is unsuccessful, the cashier carries out a manual reading of the bar code (4) situated on the card (1) externally visible on the reusable bag, viewing each time on an available display the face of the client previously stored in an archive (9) of the business establishment, the related search being actuated on the basis of said bar code printed on the card (1).

7. A method for recording and identifying the single client who purchases products with continuity in a business establishment according to claim 1, characterized in that the client who is about to bring his purchases to the checkout counter together with the bag containing the contactless card (1) comes to be situated close to a reader (12), which interrogates said card, whose relative transceiving circuit (5) after having recognized the command transmits its own alphanumeric identification; since the client in possession of the bag has approached the checkout counter, he is filmed by an exit telecamera (16″), and from the relative photographs a dedicated processor obtains the identification for the final recognition, and at the same time the comparison is carried out with the code present on the card (1), the endorsement and the relative deducting of the purchase amount from the current account balance occurring in an automatic manner.

8. A method for recording and identifying the single client who purchases products with continuity in a business establishment according to claim 1, characterized in that it actuates an identification in a direct manner, via scanning by the reader (12) of only the bar code corresponding with the image of the client face and with the relative card (1) owned by such client, the recognition being carried out by the personnel via comparison of the face of the client at the entrance with the image obtained from the user data bank (9), which is reported on a display, and from here the different prepaid card/prepayment management functions derive, together with the updating of the access number and point total.

9. A method for recording and identifying the single client who purchases products with continuity in a business establishment according to claim 1, characterized in that it employs, in a parallel and concurrent manner, two instruments for authenticating the card owner:
a—the telecamera (16) which takes the digital photographs of the client approaching the checkout counter, from whose transcoding the comparison is made with the identification contained in the card (1), associated with the reusable bag, for the facial recognition, with visual indication of success or non-success of the relative comparison,
b—a display for the cashier, on which the image—the face—of the client appears, retrieved from a proprietary archive (9) of the business establishment, on the basis of the identification contained in the card itself, acquired by means of RF connection, and if the image does not coincide, the cashier making use of the bar code (4) on the card, by means of manual reading of the same for the retrieval of the image in the proprietary archive (9), and the reader system, based on the redundancy of the procedures, ensures the security of the deciphered data and updates the information contained in the card (1) and in the archive (9).

10. A method for recording and identifying the single client who purchases products with continuity in a business establishment according to claim 1, characterized in that it employs a cell phone, provided with NFC functionalities for the payments and with Bluetooth connection, communicating with a transceiving device, also of Bluetooth type, situated on the card (1) inserted in a removable manner in the recyclable bag, the card (1) on which the client's facial recognition is based communicating with the electronic device of cell phone type, over Bluetooth frequencies and with Bluetooth protocol, such that when the telecamera (16) at the exit, at the time of payment of the shopping bill, detects the presence of a card (1), it takes a series of photographs of the user, and the imprint obtained by means of dedicated algorithm is compared with the key stored in the card (1), the successful outcome of the comparison allowing the enabling of the payment function with the NFC cell phone which is recognized as owned by the paying client.

11. A system for recording and identifying the single client who purchases products with continuity in a business establishment according to claim 2, characterized in that the following are included on the digital card (1): a magnetic band (7), a CPU (10), a photovoltaic cell (3), with a power supply circuit and capacitive circuits and/or rechargeable battery, one or more RFID RxTx units (5), with relative antenna, a memory unit (2) dedicated to containing the encryption and authentication keys for the facial recognition and a memory unit (8) with the various files in which the digital data is preserved relative to the client's facial recognition, to be employed for the relative identification on the basis of the authentication and (de)ciphering process actuated via the authentication keys contained in the identification medium (2).

12. A method for recording and identifying the single client who purchases products with continuity in a business establishment according to claim 2, characterized in that it comprises the following operating steps:
a—at the time of access to the business area, a detection device (16), such as a telecamera, activates a procedure for controlling the validity of the RF card (1) of the client inserted in the bag in his possession,
b—the telecamera (16) takes a series of photographs and carries out the relative digitization of the image for a first possible RF recognition through the comparison—made by a dedicated processor—of the data related to the image stored in the card (1) with the data currently detected by the telecamera system,
c—1 if the user is not recognized, he moves himself with respect to the filming device (16) so as to change the filming angle,
c—2 if the user is still not recognized, he is requested to be manually identified through the scanning of the bar code which is situated on the same card (1), in a visible manner, in zone (4) of the card.

13. A method for recording and identifying the single client who purchases products with continuity in a business establishment according to claim 2, characterized in that the identification of the bag and thus of the client is included in the contactless card (1), and the card itself constitutes the payment item, since credit can be added thereto—according to client needs—with transactions that make use of proprietary encryption algorithms, so that when the client enters the business establishment, the detection devices such as the telecamera (16) execute the facial scanning of the client according to a predefined transcoding algorithm, a dedicated processor immediately actuates its conversion into a binary code constituting the identification and, at the same time for the purposes of payment authentication, executes the comparison with the code stored in the card (1) at the time of issue of the same, such stored code also corresponding to the coding of the facial image.

14. A method for recording and identifying the single client who purchases products with continuity in a business establishment according to claim 2, characterized in that a checkout employee establishes the bag ownership in real time, on a display available thereto which each time displays the face of the client previously stored in an archive (9) situated at the business establishment, the relative search being actuated on the basis of the identification stored in the card (1) starting from a contactless connection with a reader (12) placed near the checkout counter, and following the successful establishment of the actual ownership of the bag, the CPU (10) inserted in the card (1) executes the procedures stored in the internal program memory (8), adapted to produce the coded data exchange with the reader device (12) for managing a prepaid card/prepayment for the purpose of paying the bill at a checkout counter and acquiring the points related to the shopping carried out, and in that if such first RF connection type is unsuccessful, the cashier carries out a manual reading of the bar code (4) situated on the card (1) externally visible on the reusable bag, viewing each time on an available display the face of the client previously stored in an archive (9) of the business establishment, the related search being actuated on the basis of said bar code printed on the card (1).

15. A method for recording and identifying the single client who purchases products with continuity in a business establishment according to claim 2, characterized in that the client who is about to bring his purchases to the checkout counter together with the bag containing the contactless card (1) comes to be situated close to a reader (12), which interrogates said card, whose relative transceiving circuit (5) after having recognized the command transmits its own alphanumeric identification; since the client in possession of the bag has approached the checkout counter, he is filmed by an exit telecamera (16″), and from the relative photographs a dedicated processor obtains the identification for the final recognition, and at the same time the comparison is carried out with the code present on the card (1), the endorsement and the relative deducting of the purchase amount from the current account balance occurring in an automatic manner.

16. A method for recording and identifying the single client who purchases products with continuity in a business establishment according to claim 2, characterized in that it actuates an identification in a direct manner, via scanning by the reader (12) of only the bar code corresponding with the image of the client face and with the relative card (1) owned by such client, the recognition being carried out by the personnel via comparison of the face of the client at the entrance with the image obtained from the user data bank (9), which is reported on a display, and from here the different prepaid card/prepayment management functions derive, together with the updating of the access number and point total.

17. A method for recording and identifying the single client who purchases products with continuity in a business establishment according to claim 2, characterized in that it employs, in a parallel and concurrent manner, two instruments for authenticating the card owner:
a—the telecamera (16) which takes the digital photographs of the client approaching the checkout counter, from whose transcoding the comparison is made with the identification contained in the card (1), associated with the reusable bag, for the facial recognition, with visual indication of success or non-success of the relative comparison,
b—a display for the cashier, on which the image—the face—of the client appears, retrieved from a proprietary archive (9) of the business establishment, on the basis of the identification contained in the card itself, acquired by means of RF connection, and if the image does not coincide, the cashier making use of the bar code (4) on the card, by means of manual reading of the same for the retrieval of the image in the proprietary archive (9), and the reader system, based on the redundancy of the procedures, ensures the security of the deciphered data and updates the information contained in the card (1) and in the archive (9).

18. A method for recording and identifying the single client who purchases products with continuity in a business establishment according to claim 2, characterized in that it employs a cell phone, provided with NFC functionalities for the payments and with Bluetooth connection, communicating with a transceiving device, also of Bluetooth type, situated on the card (1) inserted in a removable manner in the recyclable bag, the card (1) on which the client's facial recognition is based communicating with the electronic device of cell phone type, over Bluetooth frequencies and with Bluetooth protocol, such that when the telecamera (16) at the exit, at the time of payment of the shopping bill, detects the presence of a card (1), it takes a series of photographs of the user, and the imprint obtained by means of dedicated algorithm is compared with the key stored in the card (1), the successful outcome of the comparison allowing the enabling of the payment function with the NFC cell phone which is recognized as owned by the paying client.
